(19) United States
(12) Patent Application Publication
(10) Pub. No.: US 2026/0085772 A1
(43) Pub. Date: Mar. 26, 2026

(54) MULTILAYER TUBE

(71) Applicant: Sumitomo Riko Company Limited, Aichi (JP)

(72) Inventors: Masashi OKAHISA, Aichi (JP); Koji MIZUTANI, Aichi (JP)

(73) Assignee: Sumitomo Riko Company Limited, Aichi (JP)

(21) Appl. No.: 19/347,268

(22) Filed: Oct. 1, 2025

Related U.S. Application Data
(63) Continuation of application No. PCT/JP2024/021467, filed on Jun. 13, 2024.

(30) Foreign Application Priority Data
Jun. 21, 2023 (JP) 2023-101754

(51) Int. Cl. F16L 11/04; B32B 1/08; B32B 7/12; B32B 27/08; B32B 27/32; B32B 27/34

(52) U.S. Cl. CPC F16L 11/04; B32B 1/08; B32B 7/12; B32B 27/08; B32B 27/32; B32B 27/34; B32B 2250/02; B32B 2250/24; B32B 2307/306; B32B 2307/5825; B32B 2307/737; B32B 2597/00

(57) ABSTRACT

Provided is a multilayer tube having excellent tear strength in a length direction and increased interlayer adhesion. The multilayer tube comprises an inner layer comprising polypropylene; and an outer layer comprising polyamide. The multilayer tube may have an adhesive layer between the inner layer and the outer layer, where the adhesive layer comprises a resin composition comprising particles of an organic polymer in a matrix of an acid-modified polypropylene. Alternatively, the multilayer tube comprises an inner layer comprising polypropylene; and an outer layer comprising polyamide, where the inner layer comprises a resin composition comprising particles of an organic polymer in a matrix of an acid-modified polypropylene.

### RELATED APPLICATIONS

This application is a continuation of International Application No. PCT/JP2024/021467, filed on Jun. 13, 2024, which claims priorities to JP 2023-101754 which was filed on Jun. 21, 2023, the entire contents of each of which are herein incorporated by reference.

### TECHNICAL FIELD

The present disclosure relates to a multilayer tube, and more particularly to a multilayer tube suitable as a tube for transporting a coolant in a cooling system of vehicles such as automobiles.

### BACKGROUND ART

Tubes for transporting a coolant in a cooling system of gasoline automobiles, electric automobiles, etc. include a coolant transport tube. For the coolant transport tube, a polyamide resin is commonly adopted from the viewpoint of heat resistance. Additionally, a polypropylene resin, which is advantageous in cost, has also been investigated. Further, a multilayer tube made of the polyamide resin and the polypropylene resin has also been investigated.

### RELATED ART DOCUMENT

### Patent Document

JP-A-2008-507436
JP-A-2012-082885

### SUMMARY

### Problems to be Solved by the Disclosure

The multilayer tube made of the polypropylene resin and the polyamide resin has poor adhesion between the resins. In JP-A-2012-082885, it is investigated to increase the adhesion to the polyamide resin by using an acid-modified polypropylene for the polypropylene resin. However, layers in the multilayer tube formed by extrusion tend to be oriented along the length direction. Use of the acid-modified polypropylene for the polypropylene resin causes the tube to tend to tear in a fibrous manner, and weakens the tear strength in the length direction.

An object to be solved by the present disclosure is to provide a multilayer tube having excellent tear strength in the length direction and increased interlayer adhesion.

### Means for Solving the Problems

A first multilayer tube according to the present disclosure is a multilayer tube comprising an inner layer comprising polypropylene; and an outer layer comprising polyamide, wherein the multilayer tube has an adhesive layer between the inner layer and the outer layer, and wherein the adhesive layer comprises a resin composition comprising particles of an organic polymer in a matrix of an acid-modified polypropylene.

A second multilayer tube according to the present disclosure is a multilayer tube comprising an inner layer comprising polypropylene; and an outer layer comprising polyamide disposed directly on the inner layer, wherein the inner layer comprises a resin composition comprising particles of an organic polymer in a matrix of an acid-modified polypropylene.

The particles of the organic polymer favorably comprise an ethylene-propylene copolymer or an ethylene polymer. A content of the particles of the organic polymer is favorably equal to or greater than 5 parts by mass and equal to or less than 20 parts by mass relative to 100 parts by mass of the matrix of the acid-modified polypropylene. An average particle size of the particles of the organic polymer is favorably equal to or greater than 0.1 μm and equal to or less than 10 μm.

The first multilayer tube according to the present disclosure favorably has one or more convex portions or concave portions on an outer peripheral surface and an inner peripheral surface of the adhesive layer. The second multilayer tube according to the present disclosure favorably has one or more convex portions or concave portions on an outer peripheral surface of the inner layer. Here, a height of the convex portion or a depth of the concave portion is favorably equal to or greater than 0.1 μm and equal to or less than 10 μm.

In the first multilayer tube according to the present disclosure, a tear strength of the adhesive layer in a length direction is favorably equal to or greater than 20 N/mm. In the second multilayer tube according to the present disclosure, a tear strength of the inner layer in a length direction is favorably equal to or greater than 20 N/mm.

An amine value of the polyamide is favorably equal to or greater than 15 mmol/kg and equal to or less than 100 mmol/kg. In the first multilayer tube according to the present disclosure, an adhesive strength on an interface between the adhesive layer and the outer layer is favorably equal to or greater than 30 N/cm. In the second multilayer tube according to the present disclosure, an adhesive strength on an interface between the inner layer and the outer layer is favorably equal to or greater than 30 N/cm.

The inner layer favorably further contains an antioxidant having a melting point of equal to or greater than 60° C. Here, the antioxidant is favorably a phenol-type antioxidant. The antioxidant is favorably a hindered-phenol-type antioxidant. Further, the polypropylene of the inner layer is favorably polypropylene having a melt-flow rate of equal to or greater than 0.2 g/10-min and equal to or less than 2.0 g/10-min and a melting point of equal to or greater than 145° C., wherein the melt-flow rate is measured at 230° C. with a load of 2.16 kg.

The first multilayer tube according to the present disclosure and the second multilayer tube according to the present disclosure are favorably for a vehicle coolant transport tube.
(1) A first multilayer tube according to the present disclosure is a multilayer tube comprising an inner layer comprising polypropylene; and an outer layer comprising polyamide, wherein the multilayer tube has an adhesive layer between the inner layer and the outer layer, and wherein the adhesive layer comprises a resin composition comprising particles of an organic polymer in a matrix of an acid-modified polypropylene.
(2) A second multilayer tube according to the present disclosure is a multilayer tube comprising an inner layer comprising polypropylene; and an outer layer comprising polyamide, disposed directly on the inner layer, wherein the inner layer comprises a resin composition comprising particles of an organic polymer in a matrix of an acid-modified polypropylene.
(3) According to the (1) or the (2), the particles of the organic polymer favorably comprise an ethylene-propylene copolymer or an ethylene polymer.
(4) According to any one of the (1) to the (3), a content of the particles of the organic polymer is favorably equal to or greater than 5 parts by mass and equal to or less than 20 parts by mass relative to 100 parts by mass of the matrix of the acid-modified polypropylene.
(5) According to any one of the (1) to the (4), an average particle size of the particles of the organic polymer is favorably equal to or greater than 0.1 μm and equal to or less than 10 μm.
(6) According to the (1), the multilayer tube favorably has one or more convex portions or concave portions on an outer peripheral surface and an inner peripheral surface of the adhesive layer.
(7) According to the (2), the multilayer tube favorably has one or more convex portions or concave portions on an outer peripheral surface of the inner layer.
(8) According to the (6) or the (7), a height of the convex portion or a depth of the concave portion is favorably equal to or greater than 0.1 μm and equal to or less than 10 μm.
(9) According to the (1), a tear strength of the adhesive layer in a length direction is favorably equal to or greater than 20 N/mm.
(10) According to the (2), a tear strength of the inner layer in a length direction is favorably equal to or greater than 20 N/mm.
(11) According to any one of the (1) to the (10), an amine value of the polyamide is favorably equal to or greater than 15 mmol/kg and equal to or less than 100 mmol/kg.
(12) According to the (1), an adhesive strength on an interface between the adhesive layer and the outer layer is favorably equal to or greater than 30 N/cm.
(13) According to the (2), an adhesive strength on an interface between the inner layer and the outer layer is favorably equal to or greater than 30 N/cm.
(14) According to any one of the (1) to the (13), the inner layer favorably further contains an antioxidant having a melting point of equal to or greater than 60° C.
(15) According to the (14), the antioxidant is favorably a phenol-type antioxidant.
(16) According to the (14), the antioxidant is favorably a hindered-phenol-type antioxidant.
(17) According to any one of the (14) to the (16), the polypropylene of the inner layer is favorably polypropylene having a melt-flow rate of equal to or greater than 0.2 g/10-min and equal to or less than 2.0 g/10-min and a melting point of equal to or greater than 145° C., wherein the melt-flow rate is measured at 230° C. with a load of 2.16 kg.
(18) According to any one of the (1) to the (17), the multilayer tube is favorably for a vehicle coolant transport tube.

### Effects of the Disclosure

The first multilayer tube according to the present disclosure is a multilayer tube comprising an inner layer comprising polypropylene; and an outer layer comprising polyamide, wherein the multilayer tube has an adhesive layer between the inner layer and the outer layer, and wherein the adhesive layer comprises a resin composition comprising particles of an organic polymer in a matrix of an acid-modified polypropylene. Thus, the tear strength of the matrix of the acid-modified polypropylene in the length direction becomes excellent, and the interlayer adhesion becomes excellent.

Additionally, the second multilayer tube according to the present disclosure is a multilayer tube including: an inner layer comprising polypropylene; and an outer layer comprising polyamide disposed directly on the inner layer, wherein the inner layer comprises a resin composition comprising particles of an organic polymer in a matrix of an acid-modified polypropylene. Thus, the tear strength of the matrix of the acid-modified polypropylene in the length direction becomes excellent, and the interlayer adhesion becomes excellent.

Here, when the particles of the organic polymer are constituted with an ethylene-propylene copolymer or an ethylene polymer, the effect of improving the tear strength of the matrix of the acid-modified polypropylene in the length direction becomes excellent.

When the content of the particles of the organic polymer is equal to or greater than 5 parts by mass and equal to or less than 20 parts by mass relative to 100 parts by mass of the matrix of the acid-modified polypropylene, a balance between the effect of improving the tear strength of the matrix of the acid-modified polypropylene in the length direction and the adhesion becomes excellent.

When the average particle size of the particles of the organic polymer is equal to or greater than 0.1 μm and equal to or less than 10 μm, a balance between the effect of improving the tear strength of the matrix of the acid-modified polypropylene in the length direction and the adhesion becomes excellent.

When the first multilayer tube according to the present disclosure has one or more convex portions or concave portions on an outer peripheral surface and an inner peripheral surface of the adhesive layer, adhesion between the adhesive layer and the outer layer and adhesion between the adhesive layer and the inner layer are improved due to an anchor effect. When the second multilayer tube according to the present disclosure has one or more convex portions or concave portions on an outer peripheral surface of the inner layer, adhesion between the inner layer and the outer layer is improved due to an anchor effect. When the height of the convex portion or the depth of the concave portion is equal to or greater than 0.1 μm and equal to or less than 10 μm, the adhesion between the adhesive layer and the outer layer, the adhesion between the adhesive layer and the inner layer, and the adhesion between the inner layer and the outer layer are improved due to the anchor effect.

In the first multilayer tube according to the present disclosure, when the tear strength of the adhesive layer in the length direction is equal to or greater than 20 N/mm, the tear strength in the length direction is excellent. In the second multilayer tube according to the present disclosure, when the tear strength of the inner layer in the length direction is equal to or greater than 20 N/mm, the tear strength in the length direction is excellent.

When the amine value of the polyamide is equal to or greater than 15 mmol/kg and equal to or less than 100 mmol/kg, the adhesion to the acid-modified polypropylene becomes excellent. Accordingly, the adhesion between the adhesive layer and the outer layer or the adhesion between the inner layer and the outer layer is improved.

In the first multilayer tube according to the present disclosure, when an adhesive strength on an interface between the adhesive layer and the outer layer is equal to or greater than 30 N/cm, the adhesion between the adhesive layer and the outer layer is excellent. In the second multilayer tube according to the present disclosure, when the adhesive strength on an interface between the inner layer and the outer layer is equal to or greater than 30 N/cm, the adhesion between the inner layer and the outer layer is excellent.

When the inner layer further contains an antioxidant having a melting point of equal to or greater than 60° C., heat resistance and extraction resistance of the inner layer are improved. When the antioxidant is a phenol-type antioxidant, the effect of improving the heat resistance of the inner layer becomes excellent. When the antioxidant is a hindered-phenol-type antioxidant, the effect of improving the heat resistance is particularly improved.

When the polypropylene of the inner layer is polypropylene having a melt-flow rate of equal to or greater than 0.2 g/10-min and equal to or less than 2.0 g/10-min and a melting point of equal to or greater than 145° C., wherein the melt-flow rate is measured at 230° C. with a load of 2.16 kg, the heat resistance and the extraction resistance of the inner layer are improved.

A first multilayer tube according to the present disclosure and a second multilayer tube according to the present disclosure are suitable for a vehicle coolant transport tube.

### BRIEF DESCRIPTION OF DRAWINGS

FIG. 1 is a configuration diagram illustrating a multilayer tube according to one embodiment of the present disclosure.

FIG. 2 is a schematic view illustrating a laminated state of the multilayer tube illustrated in FIG. 1.

FIG. 3 is a configuration diagram illustrating a multilayer tube according to another embodiment of the present disclosure.

FIG. 4 is a schematic view illustrating a laminated state of the multilayer tube illustrated in FIG. 3.

### EMBODIMENTS OF THE DISCLOSURE

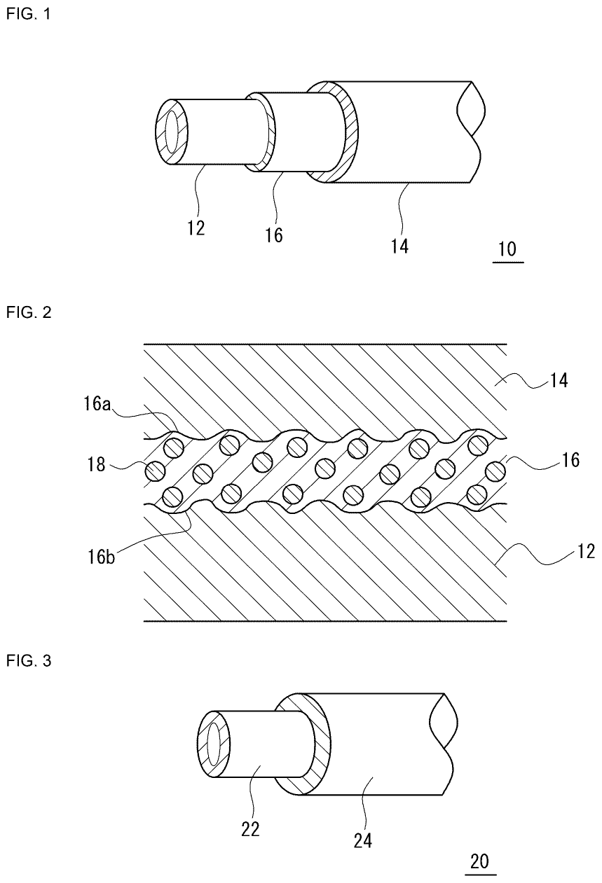

Hereinafter, the multilayer tube according to the present disclosure will be described in detail. FIG. 1 is a configuration diagram illustrating a multilayer tube according to one embodiment of the present disclosure. FIG. 2 is a schematic view illustrating a laminated state of the multilayer tube illustrated in FIG. 1.

As illustrated in FIG. 1, a multilayer tube 10 according to one embodiment of the present disclosure has an inner layer 12, an outer layer 14, and an adhesive layer 16. Each of the inner layer 12, the outer layer 14, and the adhesive layer 16 are tubularly configured. The multilayer tube 10 has a three-layer laminated structure in which the inner layer 12, the adhesive layer 16, and the outer layer 14 are tubularly laminated in this order from the inner side. The adhesive layer 16 is arranged between the inner layer 12 and the outer layer 14 as a layer to bond the inner layer 12 and the outer layer 14. The adhesive layer 16 is arranged on an outer peripheral surface of the inner layer 12 to be contacted with the inner layer 12. The outer layer 14 is arranged on an outer peripheral surface of the adhesive layer 16 to be contacted with the adhesive layer 16.

The multilayer tube 10 has the inner layer 12 containing polypropylene and the outer layer 14 containing polyamide. The outer layer 14 containing polyamide achieves the strength and the heat resistance. The inner layer 12 containing polypropylene prevents a fluid flowing in the multilayer tube 10 from contacting with the outer layer 14 containing polyamide to inhibit deterioration in the strength due to hydrolysis. The inner layer 12 containing polypropylene is protected by the outer layer 14 containing polyamide from the inner pressure of the fluid flowing in the multilayer tube 10, and thus, interlayer adhesion is important for the inner layer 12 containing polypropylene and the outer layer 14 containing polyamide. Since polypropylene and polyamide typically exhibit poor adhesion, in the multilayer tube 10, the adhesive layer 16 is arranged as a layer to bond the inner layer 12 and the outer layer 14.

The inner layer 12 is constituted with a composition containing polypropylene. The inner layer 12 contains polypropylene as a main component. The main component refers to a component of which a content is equal to or greater than 50 mass %, preferably equal to or greater than 70 mass %, more preferably equal to or greater than 90 mass %, and further preferably equal to or greater than 95 mass %.

Examples of polypropylene of the inner layer 12 include propylene-type polymers such as a propylene homopolymer, a propylene-α-olefin random copolymer, and a propylene-α-olefin block copolymer. Among these, the propylene-α-olefin block copolymer is preferable. Examples of the α-olefin include ethylene, 1-butene, 1-hexene, 4-methyl-1-pentene, and 1-octene. Among these, ethylene, 1-butene, and 1-hexene are preferable, and ethylene is particularly preferable.

The propylene-α-olefin block copolymer refers to a concept that is not limited to a block copolymer having at least a block composed of repeating propylene monomer units and a block composed of repeating α-olefin monomer units, but that encompasses an alloy (a mixture) having a sea-island structure with, for example, a polypropylene component such as a homopolymer of propylene as a sea phase and a polyethylene component and/or an ethylenic rubber component as an island phase. Examples of the polyethylene component include an ethylene homopolymer and ethylenic copolymers such as an ethylene-vinyl acetate copolymer, an ethylene-acrylic acid copolymer, an ethylene-methacrylic acid copolymer, a copolymer of ethylene and an α-olefin (an ethylene-propylene copolymer, an ethylene-butene copolymer, and an ethylene-octene copolymer). Examples of the ethylenic rubber component include an ethylene-propylene-diene terpolymer (EPDM), an ethylene-propylene copolymer (EPR), an ethylene-butene copolymer (EBR), and an ethylene-octene copolymer (EOR). A content rate of the polyethylene component and/or the ethylenic rubber component relative to the entirety of the alloy (the mixture) is, for example, 1-49 mass % or 2.5-20 mass %.

In the composition to constitute the inner layer 12, a stabilizer, a lubricant, a pigment, a dye, an antistatic agent, a plasticizer, an antioxidant, etc. can be added as necessary in addition to the polypropylene. Additionally, these materials to be used as the material for the composition to constitute the inner layer 12 are subjected to melt kneading and pelletized as necessary.

The outer layer 14 is constituted with a composition containing polyamide. The outer layer 14 contains polyamide as a main component. The main component refers to a component of which a content is equal to or greater than 50 mass %, preferably equal to or greater than 70 mass %, more preferably equal to or greater than 90 mass %, and further preferably equal to or greater than 95 mass %. The polyamide may be an aliphatic polyamide or may be an aromatic polyamide. The polyamide is more preferably the aliphatic polyamide from the viewpoints of compatibility with the polypropylene, etc.

The polyamide has an amine value of preferably equal to or greater than 15 mmol/kg from the viewpoints of improvement of the adhesion to the acid-modified polypropylene, etc. The amine value is more preferably equal to or greater than 20 mmol/kg, and further preferably equal to or greater than 25 mmol/kg. Meanwhile, from the viewpoints of an excellent extrusion molding property, etc., the amine value is preferably equal to or less than 100 mmol/kg. The amine value is more preferably equal to or less than 80 mmol/kg, and further preferably equal to or less than 60 mmol/kg. The amine value of the polyamide indicates a number of mmol of an amine contained in one kilogram of a solid content of the polyamide. The outer layer 14 favorably contains equal to or greater than 50 mass % of a polyamide exhibiting the specific amine value. The content is preferably equal to or greater than 70 mass %, more preferably equal to or greater than 90 mass %, and further preferably equal to or greater than 95 mass %.

Examples of the polyamide exhibiting the specific amine value include: aliphatic polyamides such as polyamide 46 (PA46), polyamide 410 (PA410), polyamide 6 (PA6), polyamide 66 (PA66), polyamide 610 (PA610), polyamide 612 (PA612), polyamide 11 (PA11), polyamide 12 (PA12), and polyamide 1010 (PA1010); and aromatic polyamides such as polyamide 6T (PA6T), polyamide 9T (PA9T), and polyamide 10T (PA10T). As the polyamide of the outer layer 14, these may be used alone or in combination of two or more kinds thereof.

The polyamide preferably has a melting point of equal to or greater than 160° C. from the viewpoint of the heat resistance. The melting point is more preferably equal to or greater than 170° C. Meanwhile, from the viewpoints of achievement of the adhesion, etc., the melting point is preferably equal to or less than 280° C. The melting point is more preferably equal to or less than 270° C.

In the composition to constitute the outer layer 14, a stabilizer, a lubricant, a pigment, a dye, an antistatic agent, a plasticizer, an antioxidant, etc. can be added as necessary in addition to the polyamide. Additionally, these materials to be used as the material for the composition to constitute the outer layer 14 are subjected to melt kneading and pelletized as necessary.

The adhesive layer 16 contains an acid-modified polypropylene as a matrix polymer, and is constituted with a resin composition containing particles 18 of an organic polymer in the matrix of the acid-modified polypropylene. The matrix polymer is a main component in the adhesive layer 16. The main component refers to a component of which a content is equal to or greater than 50 mass %, preferably equal to or greater than 70 mass %, more preferably equal to or greater than 90 mass %, and further preferably equal to or greater than 95 mass %. The polymer component in the adhesive layer 16 may be constituted with only the acid-modified polypropylene, or may contain a polymer component such as polypropylene that is not modified with an acid. In this case, a content of the acid-modified polypropylene among the polymer components in the adhesive layer 16 is favorably preferably equal to or greater than 70 mass %, more preferably equal to or greater than 90 mass %, and further preferably equal to or greater than 95 mass %.

Examples of the acid for the acid-modified polypropylene include unsaturated carboxylic acids and derivatives thereof. Examples of the unsaturated carboxylic acids include maleic acid, fumaric acid, acrylic acid, and methacrylic acid. Examples of the unsaturated carboxylic acid derivatives include acid anhydrides, esters, amides, imides, and metal salts. Among these, maleic acid and maleic anhydride are particularly preferable from the viewpoints of reactivity with the polyamide, etc.

An amount of acid modification in the acid-modified polypropylene is preferably equal to or greater than 0.05 mass % from the viewpoints of improvement of adhesion to the outer layer 14, etc. The amount is more preferably equal to or greater than 0.1 mass %. Meanwhile, the amount of acid modification is preferably equal to or less than 7 mass % from the viewpoints of achievement of heat resistance, etc. The amount is more preferably equal to or less than 5 mass %. Additionally, the acid-modified polypropylene preferably has a melting point of equal to or greater than 130° C. from the viewpoints of achievement of the heat resistance, etc. The melting point is more preferably equal to or greater than 140° C. Meanwhile, the melting point is preferably equal to or less than 180° C. from the viewpoints of achievement of the adhesion, etc. The melting point is more preferably equal to or less than 170° C.

The particles 18 of the organic polymer are arranged in the matrix polymer (the acid-modified polypropylene) of the adhesive layer 16. In the multilayer tube 10 to be molded by extrusion, the matrix polymer (the acid-modified polypropylene) of the adhesive layer 16 oriented in the length direction tends to tear in a fibrous manner, which weakens the tear strength in the length direction. The particles 18 of the organic polymer arranged in the matrix polymer of the adhesive layer 16 resist the tear force in the length direction, and thus, it is presumed that the tear strength in the length direction is improved.

Examples of the particles 18 of the organic polymer include particles 18 of an organic polymer such as rubber and resin. Examples of the rubber material include an ethylene-propylene copolymer, an ethylene-octene copolymer, an ethylene-butene copolymer, an ethylene-hexene copolymer, and ethyl acrylate. Examples of the resin include polyethylene. As the particles 18 of the organic polymer, these may be used alone or in combination of two or more kinds thereof. Among these, the ethylene-propylene copolymer and polyethylene are more preferable from the viewpoints of more excellent compatibility with the matrix polymer, an excellent effect of improving the tear strength of the matrix of the acid-modified polypropylene in the length direction, etc.

The particles 18 of the organic polymer may be granulated in advance and then added to the matrix polymer, or an ungranulated organic polymer may be subjected to melt kneading with the matrix polymer under a specific condition and then pelletized, and then molded by melt extrusion under a specific condition so that the particles 18 of the organic polymer are contained in the matrix of the acid-modified polypropylene.

A content of the particles 18 of the organic polymer is preferably equal to or greater than 5 parts by mass relative to 100 parts by mass of the matrix of the acid-modified polypropylene from the viewpoints of an excellent effect of improving the tear strength of the matrix of the acid-modified polypropylene in the length direction, etc. The content is more preferably equal to or greater than 10 parts by mass. Meanwhile, the content is preferably equal to or less than 20 parts by mass relative to 100 parts by mass of the matrix of the acid-modified polypropylene from the viewpoints of achievement of the adhesion due to the acid-modified polypropylene, etc. The content is more preferably equal to or less than 15 parts by mass. The content of the particles 18 of the organic polymer in the adhesive layer 16 may be obtained by capturing the image with a scanning electron microscope (SEM) at a magnification of 1000 times and performing binary coded processing, etc.

The average particle size of the particles 18 of the organic polymer is preferably equal to or greater than 0.1 μm from the viewpoints of an excellent effect of improving the tear strength of the matrix of the acid-modified polypropylene in the length direction, etc. The average particle size is more preferably equal to or greater than 0.3 μm. Meanwhile, the average particle size is preferably equal to or less than 10 μm from the viewpoints of achievement of the adhesion due to the acid-modified polypropylene, etc. The average particle size is more preferably equal to or less than 5 μm, and further preferably equal to or less than 3 μm. The average particle size of the particles 18 of the organic polymer may be indicated by an average obtained by capturing an image of a cross section of the adhesive layer 16 with a scanning electron microscope (SEM) at a magnification of 5000 times, and measuring the particle sizes of any ten of the observed particles 18 of the organic polymer.

In the composition to constitute the adhesive layer 16, a stabilizer, a lubricant, a pigment, a dye, an antistatic agent, a plasticizer, an antioxidant, etc. can be added as necessary in addition to the acid-modified polypropylene and the particles 18 of the organic polymer. Additionally, these materials to be used as the material for the composition to constitute the adhesive layer 16 are subjected to melt kneading and pelletized as necessary.

As illustrated in FIG. 2, the multilayer tube favorably has one or more convex portions or concave portions on the outer peripheral surface 16a and the inner peripheral surface 16b of the adhesive layer 16. The adhesion between the adhesive layer 16 and the outer layer 14 and the adhesion between the adhesive layer 16 and the inner layer 12 are improved by the anchor effect. A height of the convex portion or a depth of the concave portion is favorably equal to or greater than 0.1 μm and equal to or less than 10 μm. The height or the depth is more preferably equal to or greater than 0.1 μm and equal to or less than 5 μm. The adhesion between the adhesive layer 16 and the outer layer 14 and the adhesion between the adhesive layer 16 and the inner layer 12 are improved by the anchor effect. The convex portion and the concave portion are relative concepts, and either of them may be used in description.

The multilayer tube preferably has equal to or greater than two per 100 μm of the convex portions or the concave portions in the length direction at any position from the viewpoint of the anchor effect. Additionally, the multilayer tube preferably has equal to or greater than two per 100 μm of the convex portions or the concave portions in the peripheral direction at any position. Meanwhile, the number is preferably equal to or less than 100 per 100 μm in the length direction at any position from the viewpoints of achievement of the adhesion due to the acid-modified polypropylene, etc. The number is preferably equal to or less than 100 per 100 μm in the peripheral direction at any position. The number of the convex portions or the concave portions may be calculated by capturing images of a cross section of the adhesive layer 16 from a predetermined direction with a scanning electron microscope (SEM) at a magnification of 5000 times, and connecting ten of the images.

The convex portions or the concave portions may be formed due to blending of the particles 18 of the organic polymer, by changing an extrusion temperature for each layer to broaden a difference in viscosity of each layer, etc.

The tear strength of the adhesive layer 16 in the length direction is preferably equal to or greater than 20 N/mm. The tear strength is more preferably equal to or greater than 25 N/mm, and further preferably equal to or greater than 30 N/mm. For example, the tear strength may be satisfied by the adhesive layer 16 constituted with the resin composition containing the particles 18 of the organic polymer in the matrix of the acid-modified polypropylene. The tear strength may be measured by extruding a film having a thickness of 0.3 mm and measuring the film in accordance with JIS K 6252 using a trouser-shaped test piece under a condition at room temperature and a tensile speed of 100 mm/min.

The adhesive strength on an interface between the adhesive layer 16 and the outer layer 14 is preferably equal to or greater than 30 N/cm. The adhesive strength is more preferably equal to or greater than 35 N/cm, and further preferably equal to or greater than 40 N/cm. For example, the adhesive strength on the interface may be satisfied by regulating the amount of acid modification of the acid-modified polypropylene, the amine value of the polyamide, the blending amount of the particles 18 of the organic polymer, etc. The adhesive strength may be measured by preparing a strip-shaped test piece with 10 mm from the half cut multilayer tube 10 in the axial direction, peeling the end of the test piece with nippers, etc., and grasping the peeled portion to perform delamination with a tensile tester. The tensile speed is 25 mm/min, and an average value of an adhesive strength (N/cm) when the peel strength remains stable for 30 seconds is specified as the adhesive strength.

The multilayer tube 10 may be manufactured as follows. First, each of the composition to constitute the inner layer 12, the composition to constitute the outer layer 14, and the composition to constitute the adhesive layer 16 is prepared. Each of the compositions is pelletized as necessary. Next, each of the compositions is molded by melt extrusion (molded by co-extrusion) onto a mandrel to become a tube shape by using an extruder. This procedure may yield the multilayer tube 10 having the three-layer laminated structure in which the inner layer 12, the adhesive layer 16, and the outer layer 14 are tubularly laminated in this order from the inner side.

The extrusion molding of each layer is favorably performed at a temperature of 200-350° C. (preferably 220-280° C.) and a take up speed of 1-15 m/min (preferably 3-5 m/min). Here, the melt extrusion molding (co-extrusion molding) at a temperature 20-100° C. higher than (preferably a temperature 20-80° C. higher than) the melting point of the polyamide of the outer layer 14 tends to allow the particles 18 of the organic polymer in the adhesive layer 16 to be unevenly distributed near the interface between the adhesive layer 16 and the outer layer 14 or near the interface between the adhesive layer 16 and the inner layer 12. This distribution easily forms the convex portions or the concave portions with the particles 18 of the organic polymer on the outer peripheral surface 16a and the inner peripheral surface 16b of the adhesive layer 16.

The multilayer tube 10 with the above configuration has the adhesive layer 16 constituted with the resin composition containing the particles 18 of the organic polymer in the matrix of the acid-modified polypropylene between the inner layer 12 containing the polypropylene and the outer layer 14 containing the polyamide, resulting in excellent tear strength of the matrix of the acid-modified polypropylene in the length direction and excellent interlayer adhesion.

The multilayer tube 10 is used as a radiator hose, a heater hose, an air conditioner hose, etc., as well as a cooling tube of a battery pack for an electric automobile and a fuel cell vehicle. Additionally, the multilayer tube 10 may also be used not only for an automobile, but also for any other transport machines (an industrial transport vehicle such as an airplane, a forklift, an excavator, and a crane, as well as a railway vehicle, etc.), etc.

In the multilayer tube 10, an inner diameter of the tube is preferably within a range of 2-40 mm, and more preferably within a range of 4-35 mm. A thickness of the inner layer 12 is preferably within a range of 0.1-1.9 mm, and more preferably within a range of 0.2-1.8 mm. A thickness of the outer layer 14 is preferably within a range of 0.1-1.9 mm, and more preferably within a range of 0.2-1.8 mm. A thickness of the adhesive layer 16 is preferably within a range of 0.05-0.5 mm, and more preferably within a range of 0.05-0.3 mm.

When the multilayer tube 10 is used for the vehicle coolant transportation, the inner layer 12 containing polypropylene may be required to have predetermined heat resistance. In this case, it is considered that an antioxidant is blended in the composition containing the polypropylene of the inner layer 12. When the antioxidant is blended as a material for the vehicle coolant transport tube, a component derived from the antioxidant tends to be extracted (eluted) in the coolant, resulting in a risk to cause clogging of a filter in the vehicle cooling system, etc. and a risk to cause the extracted component to increase conductivity of the coolant to cause short circuit, electric leakage, etc. Therefore, excellent heat resistance and extraction resistance are required.

When the antioxidant is used, the heat resistance and the extraction resistance are conflicting. Specifically, the blending amount of the antioxidant is required to be large from the viewpoint of improving the heat resistance, but increase in the blending amount of the antioxidant causes difficulty in inhibiting of the extraction amount of the component derived from the antioxidant against the coolant, leading to failure to achieve the extraction resistance. To avoid this conflict, use of the specific polypropylene and the specific antioxidant in combination to regulate the content ratio between the both within the specific range yields excellent heat resistance and extraction resistance.

The polypropylene of the inner layer 12 preferably has a melt-flow rate (MFR) of equal to or greater than 0.2 g/10-min and or less than 2.0 g/10-min. The melting point is preferably equal to or greater than 145° C. This yields excellent extraction resistance and heat resistance. The MFR of less than 2.0 g/10-min and the melting point of equal to or greater than 145° C. may increase compatibility between the polypropylene and the antioxidant and decrease the extraction amount into the coolant, and therefore, both the heat resistance and the extraction resistance may be highly achieved.

From the above viewpoint, the MFR of the polypropylene is more preferably equal to or less than 1.8 g/10-min, further preferably equal to or less than 1.6 g/10-min, and particularly preferably equal to or less than 1.5 g/10-min. Meanwhile, the MFR of the polypropylene is preferably equal to or greater than 0.3 g/10-min, more preferably equal to or greater than 0.4 g/10-min, and further preferably equal to or greater than 0.5 g/10-min from the viewpoints of achievement of flowability, etc. The MFR is measured in accordance with JIS K7210:1999 under a condition at 230° C. with a load of 2.16 kg.

From the above viewpoint, the melting point of the polypropylene is more preferably equal to or greater than 148° C., further preferably equal to or greater than 150° C., and particularly preferably equal to or greater than 155° C. Meanwhile, an upper limit of the melting point of the polypropylene is not particularly limited, but favorably equal to or less than 175° C. The melting point of the polypropylene may be measured by a method in accordance with JIS K7121-2012.

The antioxidant preferably has a melting point of equal to or greater than 60° C. from the viewpoints of the heat resistance and the extraction resistance. The melting point is more preferably equal to or greater than 70° C., further preferably equal to or greater than 75° C., and particularly preferably equal to or greater than 80° C. or equal to or greater than 90° C. The melting point is preferably equal to or less than 300° C., and more preferably equal to or less than 250° C.

A molecular weight of the antioxidant is not particularly limited, but, for example, preferably 550-1300, more preferably 580-1280, further preferably 600-1250, and particularly preferably 700-1200.

Examples of the antioxidant include phenol-type antioxidants, amine-type antioxidants, imidazole-type antioxidants, and phosphoric-acid-type antioxidants. As the antioxidant, only one kind thereof may be constituted, or two or more kinds thereof may be constituted. Among these, the phenol-type antioxidants are preferable from the viewpoints of more excellent heat resistance. Among the phenol-type antioxidants, hindered-phenol-type antioxidants are particularly preferable from the viewpoint of the heat resistance.

Examples of the hindered-phenol-type antioxidant include pentaerythritol tetrakis[3-(3,5-di-tert-butyl-4-hydroxyphenyl)propionate] (for example, “IRGANOX 1010,” manufactured by BASF SE, melting point: 110-125° C., molecular weight: 1178), 1,3,5-tris(3,5-di-tert-butyl-4-hydroxybenzyl)isocyanurate (for example, “IRGANOX 3114,” manufactured by BASF SE, melting point: 220-222° C., molecular weight: 784), 2,4,6-tris(4-hydroxy-3,5-di-tert-butylbenzyl)mesitylene (for example, “IRGANOX 1330,” manufactured by BASF SE, melting point: 248-252° C., molecular weight: 775), 6-(4-hydroxy-3,5-di-tert-butylanilino)-2,4-bis(octylthio)-1,3,5-triazine (for example, “IRGANOX 565,” manufactured by BASF SE, melting point: 91-96° C.), 2,2′-thiodiethylbis[3-(3,5-di-tert-butyl-4-hydroxyphenyl)propionate (for example, “IRGANOX 1035,” manufactured by BASF SE, melting point: 63-78° C.), N,N′-hexamethylenebis[3-(3,5-di-tert-butyl-4-hydroxyphenyl)propenamide] (for example, “IRGANOX 1098,” manufactured by BASF SE, melting point: 156-161° C., molecular weight: 637), and 1,6-hexanediol bis[3-(3,5-di-tert-butyl-4-hydroxyphenyl)propionate] (for example, “IRGANOX 259,” manufactured by BASF SE, melting point: 104-108° C., molecular weight: 639).

A content of the antioxidant is preferably relatively small relative to the content of the polypropylene from the viewpoints of the heat resistance and the extraction resistance. Specifically, the content is preferably equal to or greater than 0.1 part by mass and equal to or less than 1.0 part by mass relative to 100 parts by mass of the polypropylene.

The multilayer tube according to the present disclosure may be the multilayer tube having the three-layer laminated structure as illustrated in FIG. 1, or may be a multilayer tube having two-layer laminated structure of the inner layer and the outer layer in which the adhesive layer 16 is omitted. Additionally, another resin layer, a rubber layer, or a reinforcing layer (a layer formed by subjecting a reinforcing yarn such as a PET yarn to braiding, etc.) may be laminated on the outer peripheral surface of the outer layer.

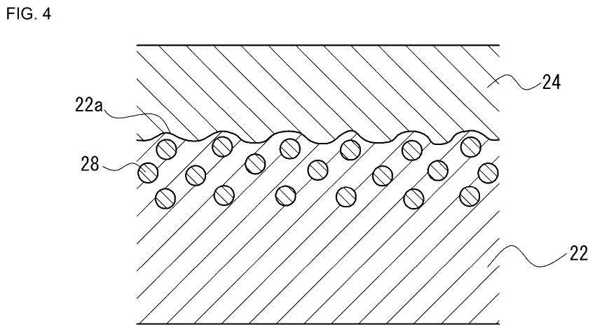

FIG. 3 illustrates a multilayer tube according to a second embodiment of the present disclosure. FIG. 4 illustrates a laminated state of the multilayer tube illustrated in FIG. 3.

As illustrated in FIG. 3, a multilayer tube 20 according to the second embodiment of the present disclosure has an inner layer 22 and an outer layer 24. Each of the inner layer 22 and the outer layer 24 is tubularly configured. The multilayer tube 20 has a two-layer laminated structure in which the inner layer 22 and the outer layer 24 are tubularly laminated in this order from the inner side. The outer layer 24 is arranged on an outer peripheral surface 22a of the inner layer 22 to be contacted with the inner layer 22.

The multilayer tube 20 has the inner layer 22 containing polypropylene and the outer layer 24 containing polyamide. The outer layer 24 containing polyamide achieves the strength and the heat resistance. The inner layer 22 containing polypropylene prevents a fluid flowing in the multilayer tube 20 from contacting with the outer layer 24 containing polyamide to inhibit deterioration in the strength due to hydrolysis. The inner layer 22 containing polypropylene is protected by the outer layer 24 containing polyamide from the inner pressure of the fluid flowing in the multilayer tube 20, and thus, interlayer adhesion is important for the inner layer 22 containing polypropylene and the outer layer 24 containing polyamide. Since polypropylene and polyamide typically exhibit poor adhesion, in the multilayer tube 20, an acid-modified polypropylene is used for the inner layer 22 contacted with the outer layer 24 containing polyamide.

The inner layer 22 contains an acid-modified polypropylene as a matrix polymer, and is constituted with a resin composition containing particles 28 of an organic polymer in the matrix of the acid-modified polypropylene. The matrix polymer is a main component in the inner layer 22. The main component refers to a component of which a content is equal to or greater than 50 mass %, preferably equal to or greater than 70 mass %, more preferably equal to or greater than 90 mass %, and further preferably equal to or greater than 95 mass %. The polymer component in the inner layer 22 may be constituted with only the acid-modified polypropylene, or may contain a polymer component such as polypropylene that is not modified with an acid. In this case, a content of the acid-modified polypropylene among the polymer components in the inner layer 22 is favorably preferably equal to or greater than 70 mass %, more preferably equal to or greater than 90 mass %, and further preferably equal to or greater than 95 mass %.

The configuration of the inner layer 22 in the multilayer tube 20 is the same as the configuration of the adhesive layer 16 in the multilayer tube 10. The configuration of the acid-modified polypropylene, the configuration of the particles 28 of the organic polymer, the configuration about other additive components, etc. are the same as the configuration of the adhesive layer 16 in the multilayer tube 10. In the inner layer 22 of the multilayer tube 20, a predetermined antioxidant may be added similarly to the inner layer 12 of the multilayer tube 10. The polypropylene of the inner layer 22 of the multilayer tube 20 may have a predetermined MFR similarly to the inner layer 12 of the multilayer tube 10.

The configuration of the outer layer 24 in the multilayer tube 20 is the same as the configuration of the outer layer 14 in the multilayer tube 10.

As illustrated in FIG. 4, the multilayer tube 20 favorably has one or more convex portions or concave portions on an outer peripheral surface 22a of the inner layer 22. The adhesion between the inner layer 22 and the outer layer 24 is improved by the anchor effect. A height of the convex portion or a depth of the concave portion is favorably equal to or greater than 0.1 μm and equal to or less than 10 μm. The height or the depth is more preferably equal to or greater than 0.1 μm and equal to or less than 5 μm. The adhesion between the inner layer 22 and the outer layer 24 is improved by the anchor effect. The convex portion and the concave portion are relative concepts, and either of them may be used in description.

The multilayer tube preferably has equal to or greater than two per 100 μm of the convex portions or the concave portions in the length direction at any position from the viewpoint of the anchor effect. Additionally, the multilayer tube preferably has equal to or greater than two per 100 μm of the convex portions or the concave portions in the peripheral direction at any position. Meanwhile, the number is preferably equal to or less than 100 per 100 μm in the length direction at any position from the viewpoints of achievement of the adhesion due to the acid-modified polypropylene, etc. The number is preferably equal to or less than 100 per 100 μm in the peripheral direction at any position. The number of the convex portions or the concave portions may be calculated by capturing images of a cross section of the inner layer 22 from a predetermined direction with a scanning electron microscope (SEM) at a magnification of 5000 times, and connecting ten of the images.

The convex portions or the concave portions may be formed due to blending of the particles 28 of the organic polymer, by changing an extrusion temperature for each layer to broaden a difference in viscosity of each layer, etc.

The tear strength of the inner layer 22 in the length direction is preferably equal to or greater than 20 N/mm. The tear strength is more preferably equal to or greater than 25 N/mm, and further preferably equal to or greater than 30 N/mm. For example, the tear strength may be satisfied by the inner layer 22 constituted with the resin composition containing the particles 28 of the organic polymer in the matrix of the acid-modified polypropylene. The tear strength may be measured in the same manner as of the tear strength of the adhesive layer 16 of the multilayer tube 10.

The adhesive strength on an interface between the inner layer 22 and the outer layer 24 is preferably equal to or greater than 30 N/cm. The adhesive strength is more preferably equal to or greater than 35 N/cm, and further preferably equal to or greater than 40 N/cm. For example, the adhesive strength on the interface may be satisfied by regulating the amount of acid modification of the acid-modified polypropylene, the amine value of the polyamide, the blending amount of the particles 28 of the organic polymer, etc. The adhesive strength on the interface may be measured in the same manner as of the adhesive strength on the interface between the adhesive layer 16 and the outer layer 14 of the multilayer tube 10.

The multilayer tube 20 may be manufactured as follows. First, each of the compositions to constitute the inner layer 22 and the composition to constitute the outer layer 24 is prepared. Each of the compositions is pelletized as necessary. Next, each of the compositions is molded by melt extrusion (molded by co-extrusion) onto a mandrel to become a tube shape by using an extruder. This procedure may yield the multilayer tube 20 having the two-layer laminated structure in which the inner layer 22 and the outer layer 24 are tubularly laminated in this order from the inner side.

The extrusion molding of each layer is favorably performed at a temperature of 200-350° C. (preferably 220-280° C.) and a take up speed of 1-15 m/min (preferably 3-5 m/min). Here, the melt extrusion molding (co-extrusion molding) at a temperature 20-100° C. higher than (preferably a temperature 20-80° C. higher than) the melting point of the polyamide of the outer layer 24 tends to allow the particles 28 of the organic polymer in the inner layer 22 to be unevenly distributed near the interface between the inner layer 22 and the outer layer 24. This distribution easily forms the convex portions or the concave portions with the particles 28 of the organic polymer on the outer peripheral surface 22a of the inner layer 22.

In the multilayer tube 20 with the above configuration having the inner layer 22 containing the polypropylene and the outer layer 24 containing the polyamide, the inner layer 22 is constituted with the resin composition containing the particles 28 of the organic polymer in the matrix of the acid-modified polypropylene, resulting in excellent tear strength of the matrix of the acid-modified polypropylene in the length direction and excellent interlayer adhesion.

The multilayer tube 20 may also be used in the same use of the multilayer tube 10. The inner diameter of the multilayer tube 20, the thickness of the inner layer 22, and the thickness of the outer layer 24 may have the same configuration as of the multilayer tube 10.

The embodiments of the present disclosure have been described above, but the present disclosure is not limited to the above embodiments in any way, and may be variously modified within a range not departing from the spirit of the present disclosure.

### EXAMPLES

Hereinafter, the present disclosure will be described in detail by using Examples and Comparative Examples.

### Examples 1-7 and Comparative Example 1

### (Outer Layer Material)

The commercially available polyamides shown below were used as outer layer materials.

### (Preparation of Adhesive Layer Material)

Each of components was blended at a blending ratio (parts by mass) shown in Table, kneaded with a twin screw extruder (“TEM-18SS,” manufactured by Toshiba Machine Co., Ltd.) at 200° C. for 5 minutes to obtain a kneaded product, and this product was pelletized to prepare an adhesive layer material.

### (Preparation of Inner Layer Material)

Each of components was blended at a blending ratio (parts by mass) shown in Table, kneaded with a twin screw extruder (“TEM-18SS,” manufactured by Toshiba Machine Co., Ltd.) at 200° C. for 5 minutes to obtain a kneaded product, and this product was pelletized to prepare an inner layer material.

### (Production of Multilayer Tube)

With the combination shown in Table, the outer layer materials, the adhesive layer materials, and the inner layer materials were subjected to melt extrusion molding (co-extrusion molding) using a multilayer extrusion molding machine capable of co-extrusion molding (manufactured by Research Laboratory of Plastics Technology Co., Ltd.) to become a tube shape, thereby producing a multilayer tube with three-layer configuration (inner layer thickness: 0.6 mm, adhesive layer thickness: 0.1 mm, outer layer thickness 0.3 mm, inner diameter: 12 mm). The extrusion temperature for each of the materials was set to be a temperature 20° C. higher than the melting point, and the take up speed was set to 3 m/min.

### Example 8 and Comparative Example 2

### (Outer Layer Material)

The commercially available polyamides shown below were used as outer layer materials.

### (Preparation of Inner Layer Materials)

Each of components was blended at a blending ratio (parts by mass) shown in Table, kneaded with a twin screw extruder (“TEM-18SS,” manufactured by Toshiba Machine Co., Ltd.) at 200° C. for 5 minutes to obtain a kneaded product, and this product was pelletized to prepare an inner layer material.

### (Production of Multilayer Tube)

With the combination shown in Table, the outer layer materials and the inner layer materials were subjected to melt extrusion molding (co-extrusion molding) using a multilayer extrusion molding machine capable of co-extrusion molding (manufactured by Research Laboratory of Plastics Technology Co., Ltd.) to become a tube shape, thereby producing a multilayer tube with two-layer configuration (inner layer thickness: 0.7 mm, outer layer thickness 0.3 mm, inner diameter: 12 mm). The extrusion temperature for each of the materials was set to be a temperature 20° C. higher than the melting point, and the take up speed was set to 3 m/min.

The used materials were as follows.

### (Materials for Outer Layer)

PA<1>: Polyamide, “SX8002,” manufactured by Daicel-Evonik Co., Ltd., melting point: 211° C., amine value: 70.7 mmol/g
PA<2>: Polyamide, “Zytel RSLC3060,” manufactured by DuPont de Nemours, Inc., melting point: 223° C., amine value: 52.0 mmol/g
PA<3>: Polyamide, “CM2001,” manufactured by Toray Industries, Inc., melting point: 222° C., amine value: 18.0 mmol/g

### (Materials for Adhesive Layer)

Acid-modified PP<1>: Maleic-anhydride-modified polypropylene, “ADMER QF500,” manufactured by Mitsui Chemicals, Inc., modification amount: 0.27 mass %, melting point: 165° C.
EP copolymer <1>: Ethylene-propylene copolymer, “TAFMER DF840,” manufactured by Mitsui Chemicals, Inc.
EP copolymer <2>: Ethylene-propylene copolymer, “TAFMER DF8200,” manufactured by Mitsui Chemicals, Inc.

### (Materials for Inner Layer)

Block PP: Propylene-α-olefin block copolymer, “E-702 MG,” manufactured by Prime Polymer Co., Ltd., MFR: 1.4 g/10-min, melting point: 162° C.
Antioxidant: Phenol-type antioxidant, “IRGANOX 1010,” manufactured by BASF SE, melting point: 110-125° C.
Acid-modified PP<1>: Maleic-anhydride-modified polypropylene (ADMER QF500,” manufactured by Mitsui Chemicals, Inc.), modification amount: 0.27 mass %, melting point: 165° C.
EP copolymer <1>: Ethylene-propylene copolymer (“TAFMER DF840,” manufactured by Mitsui Chemicals, Inc.)
EP copolymer <2>: Ethylene-propylene copolymer (“TAFMER DF8200,” manufactured by Mitsui Chemicals, Inc.)

The obtained multilayer tube was cut in half, images of the laminated cross section thereof were captured with a scanning electron microscope (SEM) at a magnification of 5000 times, and ten of the images were connected. Based on the images, the particle size of any ten particles of the organic polymer observed in the adhesive layer or in the inner layer was measured to obtain the average particle size (μm) thereof. Furthermore, in the images, when convex portions were recognized on the side of the adhesive layer or the inner layer at the interface between the adhesive layer or the inner layer and the outer layer, the number of the convex protrusions (per 100 μm) was counted in a straight-line distance at the interface. The results thereof are shown in the Tables below.

For the obtained multilayer tubes, each property was evaluated in accordance with the following criteria. The results thereof are shown in the Tables below.

### <Tear Strength>

The tear strength was measured by using the materials for the adhesive layer or the materials for the inner layer, extruding a film having a thickness of 0.3 mm, and measuring the film in accordance with JIS K 6252 using a trouser-shaped test piece under a condition at room temperature and a tensile speed of 100 mm/min. A case where the tear strength was equal to or greater than 40 N/mm was evaluated as “Excellent,” a case of equal to or greater than 20 N/mm and less than 40 N/mm was evaluated as “Good,” and a case of less than 20 N/mm was evaluated as “Poor.”

<Adhesive Strength after Heat Resistance>

The produced multilayer tube was subjected to a heat treatment at 160° C. for 1 hour, then cut in half, and a strip-shaped test piece having a width of 10 mm was produced from the half-cut multilayer tube. Then, the end of the test piece was peeled with nippers, and the peeled portion was grasped and pulled to perform delamination with a tensile tester at a speed of 25 mm/min. An average value of an adhesive strength (N/cm) when the peel strength remained stable for 30 seconds was measured and described as “Adhesive strength (N/cm).” A case where the adhesive strength after heat resistance was equal to or greater than 40 N/cm was evaluated as “Excellent,” a case of equal to or greater than 20 N/cm and less than 40 N/cm was evaluated as “Good,” and a case of less than 20 N/cm was evaluated as “Fair.”

TABLE 1

| | | Example | | | | | | | Comparative |
|---|---|---|---|---|---|---|---|---|---|
| | | 1 | 2 | 3 | 4 | 5 | 6 | 7 | Example 1 |
| Outer layer | PA <1> Amine value 70.7 (mmol/g) | 100 | 100 | — | — | — | 100 | — | — |
| | PA <2> Amine value 52.0 (mmol/g) | — | — | 100 | — | — | — | 100 | 100 |
| | PA <3> Amine value 18.0 (mmol/g) | — | — | — | 100 | 100 | — | — | — |
| Adhesive | Acid-modified PP <1> | 100 | 100 | 100 | 100 | 100 | 100 | 100 | 100 |
| layer | EP copolymer <1> | 15 | 12 | 12 | 12 | 9 | 3 | 12 | — |
| | EP copolymer <2> | — | 3 | 3 | 3 | 8 | 12 | 3 | — |
| Inner layer | Block PP | 100 | 100 | 100 | 100 | 100 | 100 | 100 | 100 |
| | Antioxidant | 0.3 | 0.3 | 0.3 | 0.3 | 0.3 | 0.3 | — | 0.3 |
| Particle size of organic polymer (μm) | | 0.1 | 2.0 | 2.0 | 2.0 | 3.8 | 10.0 | 2.0 | — |
| Number of convex portions on outer peripheral | | 20 | 15 | 13 | 12 | 7 | 2 | 13 | 0 |
| surface of adhesive layer (per 100 μm) | | | | | | | | | |
| Evaluation | Tear strength of adhesive layer | >60 | 67 | 52 | 48 | 30 | 23 | 53 | 17 |
| | (N/mm) | | | | | | | | |
| | Tear strength of adhesive layer | Excellent | Excellent | Excellent | Excellent | Good | Good | Excellent | Poor |
| | Adhesive strength after heat | 55 | 52 | 49 | 41 | 21 | 17 | 44 | — |
| | resistance (N/cm) | | | | | | | | |
| | Adhesive strength after heat | Excellent | Excellent | Excellent | Excellent | Good | Fair | Excellent | — |
| | resistance | | | | | | | | |

TABLE 2

| | | | Comparative |
|---|---|---|---|
| | | Example | Example |
| | | 8 | 2 |
| Outer layer | PA <1> Amine value 70.7 (mmol/g) | — | — |
| | PA <2> Amine value 52.0 (mmol/g) | 100 | 100 |
| | PA <3> Amine value 18.0 (mmol/g) | — | — |
| Inner layer | Acid-modified PP <1> | 100 | 100 |
| | EP copolymer <1> | 12 | — |
| | EP copolymer <2> | 3 | — |
| Particle size of organic polymer (μm) | | 2.0 | — |
| Number of convex portions on outer peripheral | | 13 | 0 |
| surface of Inner layer (per 100 μm) | | | |
| Evaluation | Tear strength of inner layer (N/mm) | 49 | 17 |
| | Tear strength of inner layer | Excellent | Poor |
| | Adhesive strength after heat resistance (n/cm) | 42 | — |
| | Adhesive strength after heat resistance | Excellent | — |

In the multilayer tube of Comparative Example 1 with the three-layer configuration of the inner layer, the outer layer, and the adhesive layer, the material of the adhesive layer is constituted with only the acid-modified polypropylene, and contains no particles of the organic polymer in its matrix. Accordingly, Comparative Example 1 exhibits poor tear strength of the adhesive layer. Meanwhile, in Examples 1-7, the material of the adhesive layer is constituted with the acid-modified polypropylene and the particles of the organic polymer, and contains the particles of the organic polymer in the matrix of the acid-modified polypropylene. Accordingly, Examples exhibit excellent tear strength of the adhesive layer. Thus, the interlayer adhesion may be satisfied.

In the multilayer tube of Comparative Example 2 with the two-layer configuration of the inner layer and the outer layer, the material of the inner layer is constituted with only the acid-modified polypropylene, and contains no particles of the organic polymer in its matrix. Accordingly, Comparative Example 2 exhibits poor tear strength of the inner layer. Meanwhile, in Example 8, the material of the inner layer is constituted with the acid-modified polypropylene and the particles of the organic polymer, and contains the particles of the organic polymer in the matrix of the acid-modified polypropylene. Accordingly, Example 8 exhibits excellent tear strength of the inner layer. Thus, the interlayer adhesion may be satisfied.

The embodiments and Examples of the present disclosure have been described above, but the present disclosure is not limited to the above embodiments and Examples in any way, and may be variously modified within a range not departing from the spirit of the present disclosure.

### REFERENCE SIGNS LIST

10 MULTILAYER TUBE
12 INNER LAYER
14 OUTER LAYER
16 ADHESIVE LAYER
16a OUTER PERIPHERAL SURFACE (OF ADHESIVE LAYER)
16b INNER PERIPHERAL SURFACE (OF ADHESIVE LAYER)
18 PARTICLE OF ORGANIC POLYMER
20 MULTILAYER TUBE
22 INNER LAYER
22a OUTER PERIPHERAL SURFACE (OF INNER LAYER)
24 OUTER LAYER
28 PARTICLE OF ORGANIC POLYMER

1. A multilayer tube comprising:
an inner layer comprising polypropylene; and
an outer layer comprising polyamide,
wherein the multilayer tube has an adhesive layer between the inner layer and the outer layer,
wherein the adhesive layer comprises a resin composition comprising particles of an organic polymer in a matrix of an acid-modified polypropylene, and
wherein a content of the particles of the organic polymer is equal to or greater than 5 parts by mass and equal to or less than 20 parts by mass relative to 100 parts by mass of the matrix of the acid-modified polypropylene.

2. A multilayer tube comprising:
an inner layer comprising polypropylene; and
an outer layer comprising polyamide,
wherein the inner layer comprises a resin composition comprising particles of an organic polymer in a matrix of an acid-modified polypropylene, and
wherein a content of the particles of the organic polymer is equal to or greater than 5 parts by mass and equal to or less than 20 parts by mass relative to 100 parts by mass of the matrix of the acid-modified polypropylene.

3. The multilayer tube according to claim 1, wherein the particles of the organic polymer comprise an ethylene-propylene copolymer or an ethylene polymer.

4. The multilayer tube according to claim 2, wherein the particles of the organic polymer comprise an ethylene-propylene copolymer or an ethylene polymer.

5. The multilayer tube according to claim 1, wherein an average particle size of the particles of the organic polymer is equal to or greater than 0.1 μm and equal to or less than 10 μm.

6. The multilayer tube according to claim 2, wherein an average particle size of the particles of the organic polymer is equal to or greater than 0.1 μm and equal to or less than 10 μm.

7. The multilayer tube according to claim 1, wherein the multilayer tube comprises one or more convex portions or concave portions on an outer peripheral surface and an inner peripheral surface of the adhesive layer.

8. The multilayer tube according to claim 2, wherein the multilayer tube comprises one or more convex portions or concave portions on an outer peripheral surface of the inner layer.

9. The multilayer tube according to claim 7, wherein a height of the convex portion or a depth of the concave portion is equal to or greater than 0.1 μm and equal to or less than 10 μm.

10. The multilayer tube according to claim 8, wherein a height of the convex portion or a depth of the concave portion is equal to or greater than 0.1 μm and equal to or less than 10 μm.

11. The multilayer tube according to claim 1, wherein a tear strength of the adhesive layer in a length direction is equal to or greater than 20 N/mm.

12. The multilayer tube according to claim 2, wherein a tear strength of the inner layer in a length direction is equal to or greater than 20 N/mm.

13. The multilayer tube according to claim 1, wherein an amine value of the polyamide is equal to or greater than 15 mmol/kg and equal to or less than 100 mmol/kg.

14. The multilayer tube according to claim 1, wherein an adhesive strength on an interface between the adhesive layer and the outer layer is equal to or greater than 30 N/cm.

15. The multilayer tube according to claim 2, wherein an adhesive strength on an interface between the inner layer and the outer layer is equal to or greater than 30 N/cm.

16. The multilayer tube according to claim 1, wherein the inner layer further comprises an antioxidant having a melting point of equal to or greater than 60° C.

17. The multilayer tube according to claim 16, wherein the antioxidant is a phenol-type antioxidant.

18. The multilayer tube according to claim 16, wherein the antioxidant is a hindered-phenol-type antioxidant.

19. The multilayer tube according to claim 16, wherein the polypropylene of the inner layer is polypropylene having a melt-flow rate of equal to or greater than 0.2 g/10-min and equal to or less than 2.0 g/10-min and a melting point of equal to or greater than 145° C., wherein the melt-flow rate is measured at 230° C. with a load of 2.16 kg.

20. The multilayer tube according to claim 1, wherein the multilayer tube is for a vehicle coolant transport tube.
